(19) United States
(12) Patent Application Publication
(10) Pub. No.: US 2006/0013076 A1
(43) Pub. Date: Jan. 19, 2006

(54) Magnetooptic element and process for fabricating the same and optical isolator incorporating it

(75) Inventors: Toshiki Kishimoto, Tokyo (JP); Nobuo Nakamura, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Sumitomo Metal Mining Co., Ltd., Minato-ku, Tokyo (JP)

(21) Appl. No.: 10/531,284

(22) PCT Filed: Nov. 11, 2003
(86) PCT No.: PCT/JP03/14312

§ 371 Date: Apr. 14, 2005

(30) Foreign Application Priority Data
Nov. 15, 2002 (JP) 2002-331774
Apr. 14, 2003 (JP) 2003-108543

(51) Int. Cl. G11B 11/00

(52) U.S. Cl. 369/13.01

(57) ABSTRACT

A magnetic optical element having a Faraday rotator and a polarizer provided integrally on the light transmitting surface of the Faraday rotator; the magnetic optical element being characterized by being constituted of i) a Faraday rotator on each side of which an anti-reflection film has been formed and ii) a polarizer comprising photonic crystals which has been formed on one anti-reflection film. Then, in this magnetic optical element, insofar as no substrate for the polarizer is present, the whole magnetic optical element integrally made up of the Faraday rotator and the photonic-crystal polarizer can be made small in thickness, and hence, when cut into small chips, the chips can not easily scatter, also having the effect of enabling production of inexpensive optical isolators.

### TECHNICAL FIELD

This invention relates to a magnetic optical element which is used in optical communication, measurement and so forth, has a Faraday rotator and a polarizer, and is applicable to, e.g., optical isolators, optical circulators and optical attenuators; and also to a process for its production, and an optical isolator incorporated with this magnetic optical element.

### BACKGROUND ART

In semiconductor laser modules used in optical communication, measurement and so forth, optical isolators are used in order to prevent reflection return light (reflected return light) from returning to semiconductor laser elements and the lasing of lasers from coming unstable.

A basic external appearance of a conventional optical isolator is shown in FIG. 2. That is, the optical isolator is basically constituted of, as shown in FIG. 2, optical elements comprising two polarizers 3 and 3 falling at angles of 45° to each other in their plane of polarization, and a Faraday rotator 2 disposed between them; and magnets 4. Incidentally, in FIG. 2, reference numeral 5 denotes a substrate for placing thereon the optical isolator.

Then, forward-directed light which has been emitted from a semiconductor laser element passes through the incident-side polarizer 3, and thereafter the plane of polarization is rotated by 45° at the Faraday rotator 2. Hence, the light passes through the emergent-side polarizer 3 without any attenuation. On the other hand, as for the reflection return light, even where it has passed through the emergent-side polarizer 3, the plane of polarization is further rotated by 45° at the Faraday rotator 2. Hence, the reflection return light crosses the plane of polarization of the incident-side polarizer 3 to come intercepted. The property to intercept this reflection return light is called the isolation, which is desired to be usually 35 dB or more.

In transmission in recent years which is performed by a wavelength division multiplex, it has become necessary not only to secure characteristics at a single wavelength, but also to secure any desired characteristics in the whole multiplexed wavelength region. An optical isolator usable in the whole multiplexed wavelength region differs from the optical isolator shown in FIG. 2 (a single-type optical isolator), and is called a broadband optical isolator.

The broadband optical isolator includes, e.g., an optical isolator shown in FIG. 4. That is, the broadband optical isolator shown in FIG. 4 is one which is called a semidouble-type optical isolator, and is constituted of a polarizer 3, a Faraday rotator 2, a polarizer 3, a Faraday rotator 2 and a polarizer 3 which are each disposed in the direction of passage of light, and magnets 4 disposed on both sides of these optical elements. Reference numeral 5 in FIG. 5 also denotes a substrate for placing thereon the optical isolator.

Incidentally, in these single-type and broadband optical isolators, used in the Faraday rotator 2 is an iron garnet single-crystal film containing a rare earth element and bismuth the thickness of which in the direction of travel of light has been so controlled that the plane of polarization of incident light is rotated by 45° by the magneto-optic effect; and in the polarizer 3, used is/are a glass polarizer capable of absorbing unnecessary polarizing components or doubly refracting (birefringent) crystals such as rutile or lithium niobate.

Now, in order to enlarge communication capacity without enlarging the size of communication equipment, it is attempted in recent years to enlarge the number of semiconductor laser modules to be incorporated in a communication machine having the same size. As to the single-type and broadband optical isolators to be used therein, too, they are demanded to be made small-size and low-cost.

As methods for succeeding in making these optical isolators small-size and low-cost, a method disclosed in Japanese Patent Application Laid-open No. H08-094972 or No. H09-197345 has conventionally been employed, i.e., a method in which a polarizer and a Faraday rotator which are 10 mm×10 mm or more in size are laminated with an adhesive to make them integral to prepare an element previously and thereafter the element is cut in any desired size when used.

According to this method, elements of 10 mm square or more which are easy to handle are used and are treated all together, followed by cutting in any desired size. Hence, compared with a method in which optical elements having been cut in a small size are individually adjusted, the reduction of cost can be achieved, and also the time and labor for angular adjustment and positional adjustment can be lessened to enable them to be cut into chips having a smaller size, so that small-size optical isolators can be set up. This method has had such an advantage.

However, where in this method a glass polarizer is used as the polarizer and also the glass polarizer and the Faraday rotator are laminated to make them integral, the glass polarizer has a thickness of about 0.2 mm and the Faraday rotator has a thickness of about 0.4 mm, so that two glass polarizers and one Faraday rotator which have been laminated come to about 0.8 mm in thickness, and also three glass polarizers and two Faraday rotators which have been laminated come to about 1.4 mm in thickness. Then, where such laminates are cut in a small size of, e.g., 0.5 mm×0.5 mm, the chips come larger in thickness to tend to scatter when cut. There has been such a disadvantage.

In addition, in this method, the polarizers and the Faraday rotators are sheet by sheet laminated, and hence the manner of lamination tends to come non-uniform. This results in a poor yield as chips, and it has actually been difficult to materialize low-cost chips as expected. Moreover, needless to say, making chip size smaller makes the chips more tend to scatter. Also, noting that commercially available glass polarizers are about 15 mm×15 mm at maximum in size and that such glass polarizers are expensive, there have also been other factors which make it difficult to achieve sufficiently low cost.

Under such technical background, as a substitute for such glass polarizers having restriction on size, development is energetically made in recent years also on a polarizer making use of photonic crystals (hereinafter also “photonic-crystal polarizer”). The photonic crystals refer to an artificial periodic structure consisting of a high refractive index medium and a low refractive index medium, and those having the following function. That is, when two linear polarized light beams crossing each other enter this periodic structure, the respective polarized light beams independently have the relationship of frequency and wave vector, and hence the frequency band where the photonic band gap, i.e., the state density of photons is zero also comes specific to the respective polarized light beams. Thus, a case can be materialized in which the state density in respect to one polarized light beam in a certain frequency band is zero and the state density in respect to the other polarized light beam is not zero, and hence the photonic crystals function as a polarizer in this frequency band. Also, even if no photonic band gap is produced, the birefringence that is called structure birefringence takes place in a periodic structure having a size smaller than the wavelength the light that enters it has. On account of such birefringence as well, the photonic crystals function as a polarizer in virtue of the difference in refractive index that is due to the direction of polarization, and these may also be regarded as photonic crystals.

Then, these periodic structures reflect one polarized light beam and allow the other polarized light beam to pass while keeping wave vectors. Actually, as a polarization beam splitter (polarizer) making use of photonic crystals, an extinction ratio of 45 dB has been achieved (see the December, 1999, issue of O plus E, published by K. K. Shin-Gijutsu Communications, p.1557, right column, lines 10-15), where characteristics much superior to PBSs (polarization beam splitters) commonly having an extinction ratio of about 25 dB.

Now, in regard to methods for producing polarization beam splitters making use of the photonic crystals, various structures and methods are reported, such as a method by lithography as disclosed in U.S. Pat. No. 6,309,580, and a method in which, as disclosed in Japanese Patent No. 3288976, periodic structures are layered by sputtering on a substrate on which a fine structure has previously been formed. However, in reports having ever been made, the use of elements is limited to polarization beam splitters, and hence quartz glass or silicon is used as the substrate on which the periodic structures are to be formed (see Example 1 in Japanese Patent No. 3288976). For this reason, in magnetic optical devices making use of photonic crystals, the Faraday rotator and the polarization beam splitter are separately made up in a device (see Examples 1 and 2 in Japanese Patent Application Laid-open No. 2000-241762).

Here, in order to materialize small-sized single-type and broadband optical isolators, a photonic-crystal polarizer in which the quartz glass or silicon is used as the substrate and a Faraday rotator may be laminated with an adhesive to make up a small-sized optical isolator, or, e.g., quartz glass as the substrate may be laminated to a Faraday rotator with an adhesive and photonic crystals may be formed on this quartz glass substrate to form a photonic-crystal polarizer to make up a small-sized optical isolator. Such ideas would easily occur to those skilled in the art on the basis of the above conventional methods.

However, the methods standing on such ideas have a disadvantage that the elements integrally formed have so large a thickness that the chips tend to scatter, and have a problem that such a disadvantage is still not overcome.

Incidentally, as an example in which the Faraday rotator and the polarizer are made integral without employing the method of laminating them with an adhesive, an element is reported which makes use of a polarizer of the type that transmits only specific polarized light and absorbs polarized light crossing the former, like the glass polarizer. More specifically, Japanese Patent Application Laid-open No. H07-049468 discloses a magnetic optical element comprising an absorption type polarizer which is integrally formed on the surface of a Faraday rotator.

However, compared with the fact that the single-type optical isolator according to the prior art as shown in FIG. 2 has an insertion loss of from 0.2 to 0.3 dB and an isolation of about 35 dB, the magnetic optical element disclosed in Japanese Patent Application Laid-open No. H07-049468 has an insertion loss of 0.5 dB and also an isolation of about 30 dB. Thus, no magnetic optical element has been materialized which has sufficient performance.

The present invention has been made taking note of such problems. Accordingly, what it concerns is to provide a magnetic optical element which has the required optical characteristics and also can not easily make chips scatter, and a process for producing the same, and at the same time to provide single-type and broadband optical isolators incorporated with such a magnetic optical element.

### DISCLOSURE OF THE INVENTION

The magnetic optical element according to the present invention is, in a magnetic optical element having a Faraday rotator and a polarizer provided integrally on the light transmitting surface of the Faraday rotator, characterized by being constituted of i) a Faraday rotator on each side of which an anti-reflection film has been formed and ii) a polarizer comprising photonic crystals which has been formed on one anti-reflection film.

A magnetic optical element for a semidouble-type optical isolator according to the present invention is also characterized in that a pair of magnetic optical elements described above, each constituted of i) a Faraday rotator on each side of which an anti-reflection film has been formed and ii) a polarizer comprising photonic crystals which has been formed on one anti-reflection film are respectively laminated to a one-sheet glass polarizer on its inside and outside in such a way that each polarizer comprising photonic crystals is provided on the outside.

Next, the magnetic optical element production process according to the present invention is characterized by having steps comprising the step of forming on one surface side of a Faraday rotator an anti-reflection film for a photonic-crystal polarizer, formed of a dielectric multi-layer film the outermost layer of which is an SiO₂ layer; the step of forming periodic grooves in the SiO₂ layer of the anti-reflection film formed; the step of layering on the surface of the SiO₂ layer of the anti-reflection film in which layer the grooves have been formed, amorphous SiO₂ layers and amorphous Si layers alternately and while keeping the shape of the grooves in each layer, to form a polarizer comprising photonic crystals; and the step of forming an anti-reflection film for air or for an adhesive, on the Faraday rotator at least on its surface side where the polarizer is not formed.

Another magnetic optical element production process according to the present invention is characterized by having steps comprising the step of forming on one surface side of a Faraday rotator an anti-reflection film for a photonic-crystal polarizer, formed of a dielectric multi-layer film the outermost layer of which is an SiO₂ layer; the step of forming on the SiO₂ layer of this anti-reflection film a second SiO₂ layer for forming photonic crystals; the step of forming on the second SiO₂ layer formed a resist mask for forming photonic crystals, and etching the second SiO₂ layer at its areas uncovered through the mask, to form periodic grooves which constitute photonic crystals; and the step of removing the resist mask remaining on the polarizer comprising the photonic crystals and thereafter forming an anti-reflection film for air or for an adhesive, on the Faraday rotator at least on its surface side where the polarizer is not formed.

Next, the optical isolator according to the present invention is characterized by having a substrate for placing thereon an optical isolator, a glass polarizer disposed on the substrate, the magnetic optical element of the present invention which has been so disposed on the substrate that the Faraday rotator side is set opposite to the glass polarizer, and a magnet which imparts a saturated magnetic field to the Faraday rotator.

A broadband semidouble-type optical isolator according to the present invention is characterized by having a substrate for placing thereon an optical isolator, the magnetic optical elements for a semidouble-type optical isolator according to the present invention which are disposed on the substrate, and a magnet which imparts a saturated magnetic field to each Faraday rotator of the magnetic optical elements for a semidouble-type optical isolator.

### BRIEF DESCRIPTION OF THE DRAWINGS

FIG. 1 is a schematic perspective view showing the construction of a single-type optical isolator incorporated with the magnetic optical element according to the present invention.

FIG. 2 is a schematic perspective view showing the construction of a single-type optical isolator according to the prior art.

FIG. 3 is a schematic perspective view showing the construction of a broadband semidouble-type optical isolator incorporated with the magnetic optical element for a semidouble-type optical isolator according to the present invention.

FIG. 4 is a broadband schematic perspective view showing the construction of a broadband semidouble-type optical isolator according to the prior art.

FIGS. 5(A) to 5(E) are illustrations showing a process for producing the magnetic optical element according to the present invention.

FIGS. 6(A) to 6(G) are illustrations showing another process for producing the magnetic optical element according to the present invention.

FIGS. 7(A) to 7(C) are illustrations showing a process for producing the magnetic optical element for a semidouble-type optical isolator according to the present invention.

FIG. 8 is a schematic perspective view showing the construction of a broadband semidouble-type optical isolator in which a sectionally U-shaped magnet is used.

### BEST MODES FOR PRACTICING THE INVENTION

The present invention is described next in detail with reference to the drawings.

First, the present invention has been accomplished on the basis of the following technical findings, i.e., technical findings that photonic crystals may be formed on one anti-reflection film of a Faraday rotator on each side of which an anti-reflection film has been formed, and this enables a polarizer (polarization beam splitter) to be directly made up on the surface of the Faraday rotator, and that the employment of such a method enables mass production of small-sized single-type and broadband optical isolators free of any restriction on size that may be ascribable to conventional glass polarizers.

Here, the photonic crystals used in the present invention are those obtained by alternately layering transparent high refractive index and low refractive index mediums on rows of periodic grooves or linear projections while keeping the shape of interfaces. Then, light is made to enter such a periodic structure, whereupon the light of a TE mode (transverse electric mode) of polarized light parallel to groove rows and a TM mode (transverse magnetic mode) of polarized light crossing the groove rows is induced in the interior of the periodic structure. However, as long as the frequency of light is in the photonic band gap of the TE mode or TM mode, the light of that mode can not propagate inside the periodic structure, and the light having entered it is reflected or diffracted. On the other hand, as long as the frequency of light is in the photonic energy gap, the light is transmitted inside the periodic structure while keeping wave vectors. Hence, the photonic crystals act as a face type polarizer. Incidentally, even if no photonic band gap is produced, the birefringence that is called structure birefringence takes place in the periodic structure having a size smaller than the wavelength the light that enters it has. On account of such birefringence as well, the photonic crystals function as a polarizer in virtue of the difference in refractive index that is due to the direction of polarization. Thus, those obtained by forming periodic grooves by lithography are also included in the photonic crystals used in the present invention.

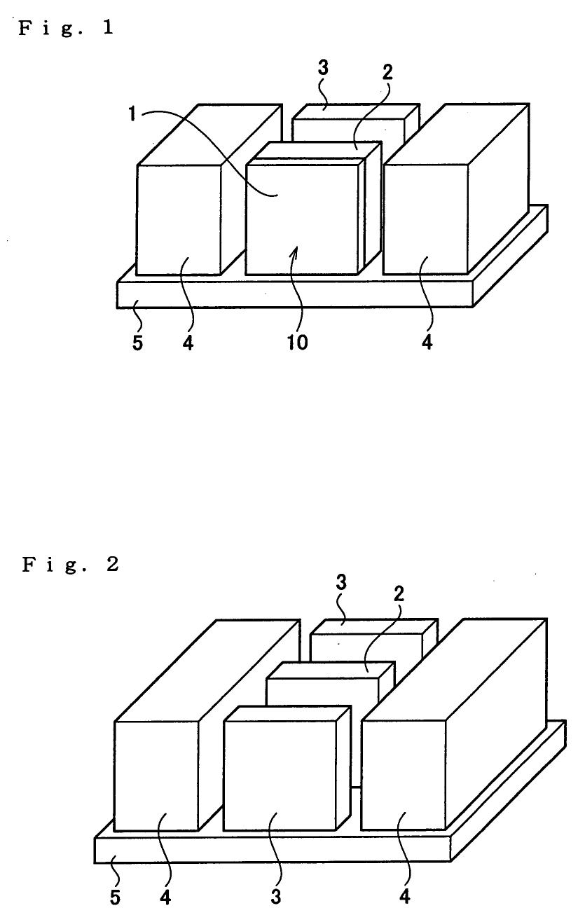

Then, as shown in FIG. 1, a magnetic optical element 10 constituted of i) a Faraday rotator 2 on each side of which an anti-reflection film has been formed and ii) a photonic-crystal polarizer 1 formed on one anti-reflection film of the Faraday rotator 2 may be disposed on a substrate 5 for placing thereon an optical isolator, and a glass polarizer 3 may be so disposed thereon as to be set opposite to the Faraday rotator 2 of the magnetic optical element 10, and also a pair of magnets 4 and 4 may respectively be disposed on both sides of these magnetic optical element 10 and glass polarizer 3, to thereby make up a single-type optical isolator.

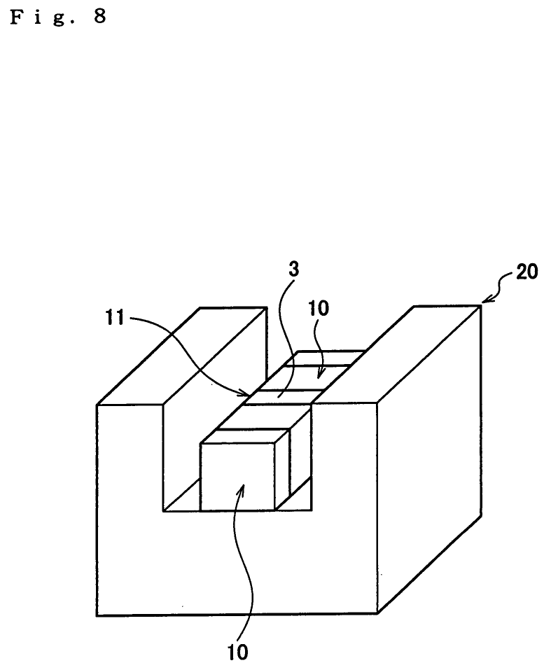

A pair of magnetic optical elements 10 shown in FIG. 1 may also respectively be laminated to a one-sheet glass polarizer 3 on its inside and outside in such a way that the photonic-crystal polarizer 1 side is on the outside, to make up a magnetic optical element 11 for a semidouble-type optical isolator, and this magnetic optical element 11 for a semidouble-type optical isolator may be, as shown in FIG. 3, disposed on a substrate 5 for placing thereon an optical isolator, and also a pair of magnets 4 and 4 may respectively be disposed on both sides of this magnetic optical element 11 for a semidouble-type optical isolator, to thereby make up a broadband optical isolator. Incidentally, in this magnetic optical element 11 for a semidouble-type optical isolator, the photonic-crystal polarizer 1 of the magnetic optical element 10 and the glass polarizer 3 are laminated in such a way that, as shown in FIGS. 7(A) and 7(B), the plane of polarization is shifted by 45° through which plane the polarized light is so transmitted as to be, after it has passed through the photonic-crystal polarizer 1 of the magnetic optical element 10, rotated by 45° at the Faraday rotator 2 and thereafter transmitted through the glass polarizer 3. As to the glass polarizer 3 and the photonic-crystal polarizer 1 of the other magnetic optical element 10, they are also laminated in such a way that, as shown in FIGS. 7(B) and 7(C), the plane of polarization is shifted by 45° through which plane the polarized light is so transmitted as to be, after it has passed through the glass polarizer 3, rotated by 45° at the Faraday rotator 2 of the magnetic optical element 10 and thereafter transmitted through the photonic-crystal polarizer 1.

As to the substrate 5 for placing thereon an optical isolator and the pair of magnets 4 and 4, they may also be constituted of, as shown in FIG. 8, a single magnet member 20 which is sectionally U-shaped.

The present invention is described below in greater detail by giving Examples of the present invention.

### EXAMPLE 1

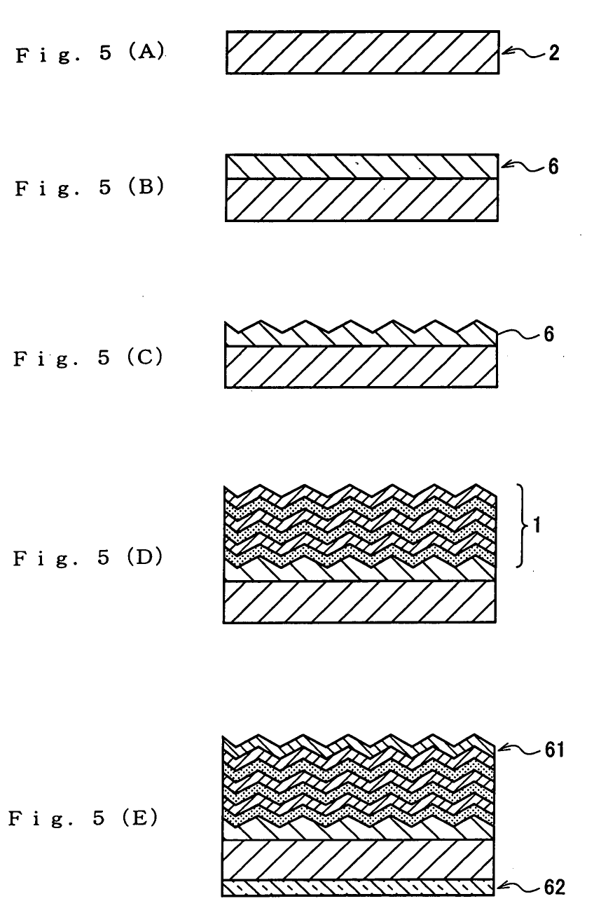

First, as shown in FIG. 5(A), a Faraday rotator 2 of 20 mm square the Faraday rotation angle of which was adjusted to 45° was made ready for use, and, as shown in FIG. 5(B), an anti-reflection film 6 for a photonic-crystal polarizer, formed of a dielectric multi-layer film the outermost layer of which was an SiO₂ layer was formed on one light-transmitting surface. In the Faraday rotator 2, used was Bi-substituted rare earth iron garnet. Here, taking account of the fact that grooves serving as seeds in forming the periodic structure are to be formed, the SiO₂ layer, the outermost layer of the anti-reflection film 6, was set to have a larger thickness than a case in which the SiO₂ layer is formed as a mere anti-reflection film.

Thereafter, as shown in FIG. 5(C), the grooves serving as seeds (here, periodic grooves with a period of 0.4 μm) were formed in the SiO₂ layer by electron beam lithography and dry etching, and thereafter amorphous SiO₂ layers and amorphous Si layers were alternately layered on the groove surfaces. At this point, these films were formed while keeping the periodic uneven shape (shape of grooves) in each layer. Then, the SiO₂ layers and Si layers were piled by ten layers each to form a photonic-crystal polarizer 1 as shown in FIG. 5(D). Thereafter, as shown in FIG. 5(E), an anti-reflection film 61 for air was formed on the surface of the photonic-crystal polarizer 1. Finally, an anti-reflection film 62 for air was also formed on the Faraday rotator 2 on its light-transmitting surface on which the photonic-crystal polarizer 1 is not layered.

Incidentally, in this Example, the above amorphous SiO₂ layers and amorphous Si layers constitute transparent high refractive index and low refractive index mediums of the photonic-crystal polarizer.

Next, the wafer thus produced (the structural member shown in FIG. 5E) was cut into chips of 1 mm square by means of a dicing machine. Thereafter, a glass polarizer 3 (see FIG. 1) the relative angle of the plane of polarization of which was set to 45° in respect to the plane of polarization of the photonic-crystal polarizer 1 and the chip were disposed on the substrate 5 for placing thereon an optical isolator, together with the magnets 4, to produce an optical isolator like the one shown in FIG. 1, and also optical measurement was made thereon. Also, the optical isolator was so made up that it was the forward direction when light was made to enter the optical isolator on its glass polarizer 3 side. Incidentally, in what is shown in FIG. 1, the glass polarizer 3 is made up separately from the Faraday rotator 2. Instead, the glass polarizer 3 may be formed integrally to the Faraday rotator 2 via an adhesive and on its side opposite to the side on which the photonic-crystal polarizer 1 of the Faraday rotator 2 has been formed. In this case, on the surface of the Faraday rotator 2 to which the glass polarizer 3 is to be bonded, an anti-reflection film for an adhesive is formed which is not the anti-reflection film for air.

The results of comparison of characteristics between this Example and an optical isolator according to the prior art shown in FIG. 2 in which a pair of glass polarizers 3 are used are shown in Table 1 below.

Then, as can be confirmed from the results shown in Table 1, it is seen that even the optical isolator according to Example 1, produced using the Faraday rotator of 20 mm square that has been impossible to use in conventional methods, can achieve substantially the same optical characteristics as those in the conventional one (provided that the value is that in a wavelength region of 1.55 μm).

TABLE 1

| | Example 1 | Prior-Art Product |
|---|---|---|
| Insertion loss: | 0.16 dB | 0.15 dB |
| Isolation: | >40 dB | >40 dB |

### EXAMPLE 2

This Example is one in which, different from Example 1 making use of photonic crystals acting as a polarizer in virtue of photonic band gaps, no photonic band gap is produced, but photonic crystals acting as a polarizer in virtue of structure birefringence are used.

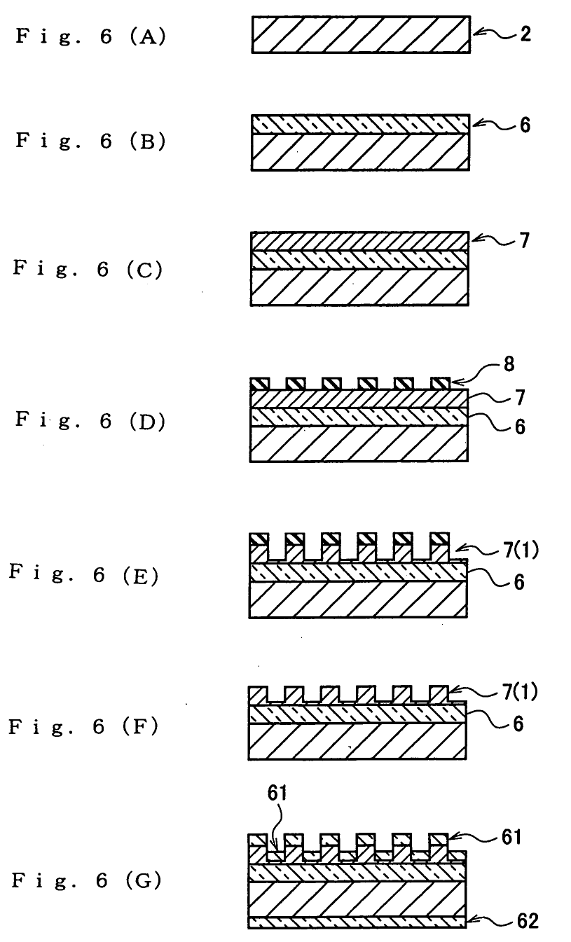

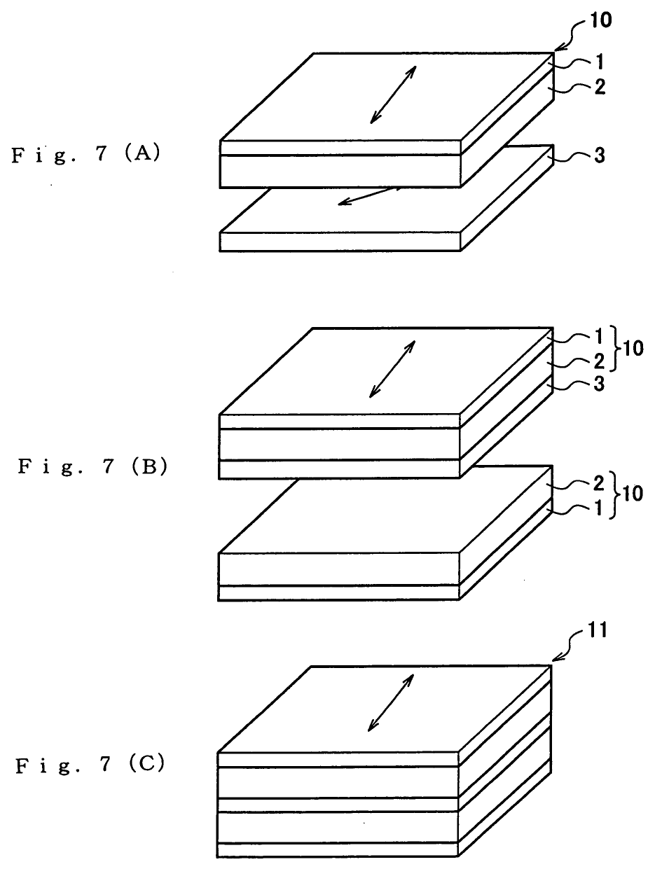

First, as shown in FIG. 6(A), a Faraday rotator 2 of 20 mm square the Faraday rotation angle of which was adjusted to 45° was made ready for use, and, as shown in FIG. 6(B), an anti-reflection film 6 for a photonic-crystal polarizer, formed of a dielectric multi-layer film the outermost layer of which was an SiO₂ layer was formed on one light-transmitting surface. In the Faraday rotator 2, used was Bi-substituted rare earth iron garnet.

Thereafter, as shown in FIG. 6(C), a second SiO₂ layer 7 of 0.8 μm in thickness was further formed on the surface of the above SiO₂ layer, and a resist layer was formed thereon.

Next, for this resist layer, as shown in FIG. 6(D) a resist mask 8 of periodic grooves (here, periodic grooves at intervals of 0.15 μm) was formed by photolithographic treatment. Incidentally, instead of the photolithography, imprinting may be used to form the resist mask 8.

Next, the surface of the second SiO₂ layer 7 on which the resist mask 8 was formed was subjected to etching treatment to form, as shown in FIG. 6(E), grooves of 0.6 μm in depth in the second SiO₂ layer 7. Incidentally, the second SiO₂ layer 7 in which the periodic grooves were formed as shown in FIG. 6(E) constitutes a photonic-crystal polarizer 1.

Next, as shown in FIG. 6(F), the resist mask 8 was removed, and thereafter, as shown in FIG. 6(G), an anti-reflection film 61 for air was formed on the surface of the second SiO₂ layer 7 in which the periodic grooves were formed. Finally, an anti-reflection film 62 for air was also formed on the Faraday rotator 2 on its light-transmitting surface on which the photonic-crystal polarizer 1 is not formed.

Incidentally, in this Example, the second SiO₂ layer 7 having remained as the periodic grooves and the air layers present between the periodic grooves in the second SiO₂ layer 7 constitute transparent high refractive index and low refractive index mediums of the photonic-crystal polarizer 1. This brings forth the structure birefringence.

Next, the wafer thus produced (the structural member shown in FIG. 6G) was cut into chips of 1 mm square by means of a dicing machine. Thereafter, a glass polarizer 3 (see FIG. 1) the relative angle of the plane of polarization of which was set to 45° in respect to the plane of polarization of the photonic-crystal polarizer 1 and the chip were disposed on the substrate 5 for placing thereon an optical isolator, together with the magnets 4, to produce an optical isolator like the one shown in FIG. 1, and also optical measurement was made thereon. Also, the optical isolator was so made up that it was the forward direction when light was made to enter the optical isolator on its glass polarizer 3 side. Incidentally, like Example 1, the glass polarizer 3 may also be formed integrally to the Faraday rotator 2 via an adhesive and on its side opposite to the side on which the photonic-crystal polarizer 1 of the Faraday rotator 2 has been formed. In this case, on the surface of the Faraday rotator 2 to which the glass polarizer 3 is to be bonded, an anti-reflection film for an adhesive is formed which is not the anti-reflection film for air.

The results of comparison of characteristics between this Example and an optical isolator according to the prior art shown in FIG. 2 in which a pair of glass polarizers 3 are used are shown in Table 2 below.

Then, as can be confirmed from the results shown in Table 2, it is seen that even the optical isolator according to Example 2, produced using the Faraday rotator of 20 mm square that has been impossible to use in conventional methods, can achieve substantially the same optical characteristics as those in the conventional one (provided that the value is that in a wavelength region of 1.55 μm).

TABLE 2

| | Example 2 | Prior-Art Product |
|---|---|---|
| Insertion loss: | 0.15 dB | 0.15 dB |
| Isolation: | >41 dB | >40 dB |

Incidentally, in both Example 1 and Example 2, as shown in FIG. 1 the glass polarizer 3 is used as the polarizer that makes a pair with the photonic-crystal polarizer 1. Instead, the polarizer may also be so made up that an absorption type polarizer is directly formed on the surface of the Faraday rotator 2 on which the photonic-crystal polarizer is not formed, without applying any adhesive between them. Also, where the optical isolator is made up, it may be so made up that it is the forward direction when light is made to enter the optical isolator on its absorption type polarizer side. This is preferable from the viewpoint of enabling the element to be kept from its temperature rise due to absorption of light.

### EXAMPLE 3

A Faraday rotator (Bi-substituted rare earth iron garnet) of 20 mm square and 0.4 mm in thickness, which has been impossible to use because of the restriction on size when conventional glass polarizers are used, was made ready for use, and, on one side of this Faraday rotator, SiO₂ and Al₂O₃ were layered to provide an anti-reflection film for SiO₂, having triple-layer structure of 0.2 μm in thickness. Incidentally, a like anti-reflection film for an adhesive was provided on the other side of the Faraday rotator.

Next, a second SiO₂ layer of 0.8 μm in thickness was formed by vacuum deposition on the surface of the anti-reflection film for SiO₂, and a resist layer was formed on this second SiO₂ layer. Thereafter, a resist mask of periodic grooves at intervals of 0.2 μm was formed by lithography (inclusive of imprinting).

Next, the second SiO₂ layer was etched at its uncovered areas to form grooves of 0.6 μm in depth, and then the mask was removed.

Next, on the surface of the second SiO₂ layer on which the grooves of 0.6 μm in depth were formed, an anti-reflection film for air of 0.2 μm in thickness was provided to obtain a magnetic optical element constituted of the Faraday rotator and the photonic-crystal polarizer. Incidentally, this magnetic optical element was in a thickness of 0.4 mm. Subsequently, a magnetic optical element having the same thickness was obtained in the same way.

Next, one magnetic optical element obtained as described above and an absorption type glass polarizer of 0.2 mm in thickness were laminated with an adhesive. Here, the photonic-crystal polarizer provided on the Faraday rotator and the absorption type glass polarizer were laminated in such a way that the plane of polarization was shifted by 45° through which plane the polarized light having passed through the photonic-crystal polarizer was so transmitted as to be rotated by 45° at the Faraday rotator 2 and thereafter transmitted through the absorption type glass polarizer.

Thereafter, to the other side of the absorption type glass polarizer, another magnetic optical element was laminated with an adhesive. Here, the absorption type glass polarizer and the photonic-crystal polarizer provided on the Faraday rotator were laminated in such a way that the plane of polarization was shifted by 45° through which plane the polarized light having passed through the absorption type glass polarizer was so transmitted as to be rotated by 45° at the Faraday rotator 2 and thereafter transmitted through the photonic-crystal polarizer.

The wafer thus obtained (the structural member shown in FIG. 7C) was 1.0 mm in total thickness. Incidentally, this thickness was only 71% of the thickness 1.4 mm of a wafer obtained using conventional three glass polarizers and two Faraday rotators.

Next, the wafer thus produced was cut into chips of 0.5 mm square by means of a dicing machine, and thereafter the chips and magnets were disposed on substrates for placing thereon optical isolators to obtain the broadband semidouble-type optical isolator shown in FIG. 3, in the number of seven hundred and twenty-nine (729). Incidentally, as to the scattering of chips when cut as having ever been problematic, it was able to cut chips without making them scatter at all, because the total thickness was 71% of conventional one.

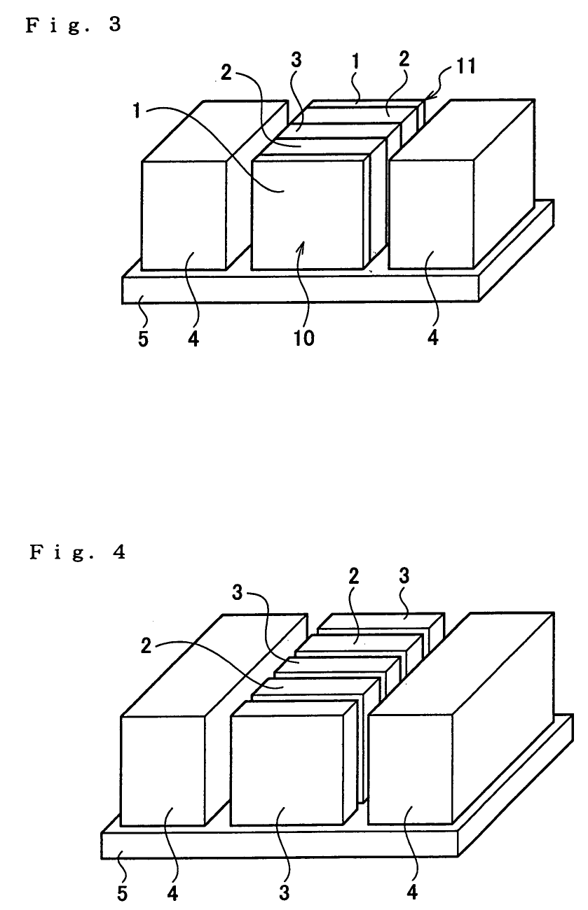

Then, twenty (20) broadband semidouble-type optical isolators were picked up at random, and also optical measurement was made thereon (provided that the value is that in a wavelength region of 1.53 to 1.59 μm). These were compared with a conventional semidouble-type optical isolator shown in FIG. 4.

The results are shown in Table 3 below. Incidentally, the values in Table 3 are average values.

TABLE 3

| | Example 3 | Prior-Art Product |
|---|---|---|
| Insertion loss: | 0.51 dB | 0.52 dB |
| Isolation: | >40 dB | >40 dB |

As can be confirmed from the results shown in Table 3, it is seen that even the broadband optical isolator produced using the wafer that has ever been impossible to use because of the restriction on size of glass polarizers can achieve substantially the same performance as that in the conventional one.

### EXAMPLE 4

As shown in FIG. 5(A), a Faraday rotator 2 of 20 mm square the Faraday rotation angle of which was adjusted to 45° was made ready for use, and, as shown in FIG. 5(B), an anti-reflection film 6 for a photonic-crystal polarizer, formed of a dielectric multi-layer film the outermost layer of which was an SiO₂ layer was formed on one light-transmitting surface. In the Faraday rotator 2, used was Bi-substituted rare earth iron garnet. Here, taking account of the fact that grooves serving as seeds in forming the periodic structure are to be formed, the SiO₂ layer, the outermost layer of the anti-reflection film 6, was set to have a larger thickness than a case in which the SiO₂ layer is formed as a mere anti-reflection film.

Thereafter, as shown in FIG. 5(C), the grooves serving as seeds (here, periodic grooves with a period of 0.4 μm) were formed in the SiO₂ layer by electron beam lithography and dry etching, and thereafter amorphous SiO₂ layers and amorphous Si layers were alternately layered on the groove surfaces. At this point, these films were formed while keeping the periodic uneven shape (shape of grooves) in each layer. Then, the SiO₂ layers and Si layers were piled by ten layers each to form a photonic-crystal polarizer 1 as shown in FIG. 5(D). Thereafter, as shown in FIG. 5(E), an anti-reflection film 61 for air was formed on the surface of the photonic-crystal polarizer 1. Finally, an anti-reflection film 62 for an adhesive was also formed on the Faraday rotator 2 on its light-transmitting surface on which the photonic-crystal polarizer 1 is not layered, to obtain a magnetic optical element constituted of the Faraday rotator 2 and the photonic-crystal polarizer 1. Subsequently, a like magnetic optical element was also obtained in the same way.

Next, one magnetic optical element obtained as described above and an absorption type glass polarizer of 0.2 mm in thickness were laminated with an adhesive. Here, the photonic-crystal polarizer 1 provided on the Faraday rotator 2 and the absorption type glass polarizer were laminated in such a way that the plane of polarization was shifted by 45° through which plane the polarized light having passed through the photonic-crystal polarizer 1 was so transmitted as to be rotated by 45° at the Faraday rotator 2 and thereafter transmitted through the absorption type glass polarizer.

Thereafter, to the other side of the absorption type glass polarizer, another magnetic optical element was laminated with an adhesive. Here, the absorption type glass polarizer and the photonic-crystal polarizer 1 provided on the Faraday rotator 2 were laminated in such a way that the plane of polarization was shifted by 45° through which plane the polarized light having passed through the absorption type glass polarizer was so transmitted as to be rotated by 45° at the Faraday rotator 2 and thereafter transmitted through the photonic-crystal polarizer 1.

The wafer thus obtained (the structural member shown in FIG. 7C) was 1.0 mm in total thickness. Incidentally, this thickness was only 71% of the thickness 1.4 mm of a wafer obtained using conventional three glass polarizers and two Faraday rotators.

Next, the wafer thus produced was cut into chips of 0.5 mm square by means of a dicing machine, and thereafter the chips and magnets were disposed on substrates for placing thereon optical isolators to obtain the broadband semidouble-type optical isolator shown in FIG. 3, in the number of seven hundred and twenty-nine (729). Incidentally, as to the scattering of chips when cut as having ever been problematic, it was able to cut chips without making them scatter at all, because the total thickness was 71% of conventional one.

Then, twenty (20) broadband semidouble-type optical isolators were picked up at random, and also optical measurement was made thereon (provided that the value is that in a wavelength region of 1.53 to 1.59 μm). These were compared with a conventional semidouble-type optical isolator shown in FIG. 4.

The results are shown in Table 4 below. Incidentally, the values in Table 4 are average values.

TABLE 4

| | Example 4 | Prior-Art Product |
|---|---|---|
| Insertion loss: | 0.52 dB | 0.52 dB |
| Isolation: | >40 dB | >40 dB |

As can be confirmed from the results shown in Table 4, it is seen that even the broadband optical isolator produced using the wafer that has ever been impossible to use because of-the restriction on size of glass polarizers can achieve substantially the same performance as that in the conventional one.

### POSSIBILITY OF INDUSTRIAL APPLICATION

According to the present invention, large-area magnetic optical elements are obtainable, also having the effect of readily mass-producing elements having the desired size. Also, insofar as no substrate for the polarizer is present, the whole magnetic optical element integrally made up of the Faraday rotator and the photonic-crystal polarizer can be made small in thickness, and hence, when cut into small chips, the chips can not easily scatter, also having the effect of enabling production of inexpensive optical isolators.

Accordingly, the present invention is suited for its application to industrial fields of single-type and broadband optical isolators, optical circulators, optical attenuators, optical switches and so forth.

1. A single-type optical isolator characterized by having a magnetic optical element constituted of i) a Faraday rotator on each side of which an anti-reflection film has been formed and ii) a polarizer comprising photonic crystals which has been formed on one anti-reflection film of the former; and a glass polarizer so disposed as to be set opposite to the anti-reflection film of the Faraday rotator in the magnetic optical element on its side where the photonic crystals are not formed.

2. A broadband semidouble-type optical isolator characterized by having a one-sheet glass polarizer; and a pair of magnetic optical elements which are each constituted of i) a Faraday rotator on each side of which an anti-reflection film has been formed and ii) a polarizer comprising photonic crystals which has been formed on one anti-reflection film of the former, and are respectively laminated to the glass polarizer on its inside and outside in such a way that each polarizer comprising photonic crystals is provided on the outside.

3. The optical isolator according to claim 1, wherein said photonic crystals are those obtained by alternately layering transparent high refractive index and low refractive index mediums on rows of periodic grooves or linear projections while keeping the shape of interfaces.

4. The optical isolator according to claim 1, wherein said photonic crystals are those obtained by forming periodic grooves by lithography.

5. The optical isolator according to claim 1, wherein an anti-reflection film has been formed on the surface of the polarizer comprising photonic crystals.

6. The optical isolator according to claim 1, wherein the outermost layer of said anti-reflection film on which the polarizer comprising photonic crystals is formed is an SiO₂ layer.

7. (canceled)

8. (canceled)

9. A single-type optical isolator characterized by being constituted chiefly of a substrate for placing thereon an optical isolator: a magnetic optical element disposed on the substrate and constituted of i) a Faraday rotator on each side of which an anti-reflection film has been formed and ii) a polarizer comprising photonic crystals which has been formed on one anti-reflection film of the former; a glass polarizer so disposed on the substrate as to be set opposite to the anti-reflection film of the Faraday rotator in the magnetic optical element on its side where the photonic crystals are not formed: and a magnet which imparts a saturated magnetic field to the Faraday rotator in the magnetic optical element.

10. A single-type optical isolator characterized by being constituted chiefly of a sectionally U-shaped magnet; a magnet optical element disposed inside the U-portion of the substrate and constituted of i) a Faraday rotator on each side of which an anti-reflection film has been formed and ii) a polarizer comprising photonic crystals which has been formed on one anti-reflection film of the former; and a glass polarizer so disposed inside the U-portion of the substrate as to be set opposite to the anti-reflection film of the Faraday rotator in the magnetic optical element on its side where the phontonic cyrstals are not formed.

11. A broadband semidouble-type optical isolator characterized by being constituted chiefly of a substrate for placing thereon an optical isolator; a one-sheet glass polarizer disposed on the substrate; a pair of magnetic optical elements which are each constituted of i) a Faraday rotator on each side of which an anti-reflection film has been formed and ii) a polarizer comprising photonic crystals which has been formed on one anti-reflection film of the former, and are respectively laminated to the glass polarizer on its inside and outside in such a way that each polarizer comprising photonic crystals is provided on the outside, and a magnet which imparts a saturated magnetic field to each Faraday rotator of the magnetic optical elements.

12. A broadband semidouble-type optical isolator characterized by being constituted chiefly of a sectionally U-shaped magnet; a one-sheet glass polarizer disposed inside the U-portion of the substrate; and a pair of magnetic optical elements disposed inside the U-portion of the substrate which are each constituted of i) a Faraday rotator on each side of which an anti-reflection film has been formed and ii) a polarizer comprising photonic crystals which has been formed on one anti-reflection film of the former and are respectively laminated to the glass polarizer on its inside and outside in such a way that each polarizer comprising photonic crystals is provided on the outside.

13. The optical isolator according to claim 2, wherein said photonic crystals are those obtained by alternately layering transparent high refractive index and low refractive index mediums on rows of periodic grooves or linear projections while keeping the shape of interfaces.

14. The optical isolator according to claim 2, wherein said photonic crystals are those obtained by forming periodic grooves by lithography.

15. The optical isolator according to claim 2, wherein an anti-reflection film has been formed on the surface of the polarizer comprising photonic crystals.

16. The optical isolator according to claim 2, wherein the outermost layer of said anti-reflection film on which the polarizer comprising photonic crystals is formed is an SiO₂ layer.
